(19) United States
(12) Patent Application Publication
(10) Pub. No.: US 2022/0135477 A1
(43) Pub. Date: May 5, 2022

(54) ULTRA HIGH PERFORMANCE CONCRETE COMPOSITION ALLOWING UNIFORM DISTRIBUTION OF REINFORCING FIBER, CONCRETE SLOTTED FLOOR MANUFACTURED USING SAME, AND METHOD FOR MANUFACTURING SAME

(71) Applicants: KOREA INSTITUTE OF CIVIL ENGINEERING AND BUILDING TECHNOLOGY, Gyeonggi-do (KR); KSC CO., LTD., Nonsan-si (KR)

(72) Inventors: Gum-Sung RYU, Goyang-si (KR); Byung-Suk KIM, Goyang-si (KR); Gi Hong AN, Paju-si (KR); Kyung-Taek KOH, Paju-si (KR); Nam-Kon LEE, Seoul (KR); Han Seok NOH, Yeosu-si (KR); Myeong Seop NOH, Nonsan-si (KR)

(21) Appl. No.: 17/509,209

(22) Filed: Oct. 25, 2021

(30) Foreign Application Priority Data
Oct. 30, 2020 (KR) 10-2020-0142761

(51) Int. Cl. C04B 18/14; C04B 7/32; C04B 14/48; C04B 16/06; C04B 14/06; C04B 40/00

(52) U.S. Cl. CPC C04B 18/146; C04B 7/323; C04B 14/48; C04B 2111/60; C04B 14/06; C04B 40/0039; C04B 16/0641

(57) ABSTRACT

The present disclosure relates to a “concrete slotted floor” manufactured from an UHPC composition which exhibits superior crack resistance due to uniform distribution of reinforcing fibers even when a residing surface is located below, allows early demolding due to fast initial setting time and exhibits improved cleaning efficiency due to maximized surface water repellency, an “UHPC composition for manufacturing the same” and a “method for manufacturing a concrete slotted floor using the same”.

### CROSS-REFERENCE TO RELATED APPLICATION

This application claims priority to Korean Patent Application No. 10-2020-0142761, filed on Oct. 30, 2020, and all the benefits accruing therefrom under 35 U.S.C. § 119, the contents of which in its entirety are herein incorporated by reference.

### BACKGROUND

### 1. Field

The present disclosure relates to an ultra high performance concrete composition (UHPC composition) allowing uniform distribution of reinforcing fibers along a thickness direction of a member, a concrete slotted floor for a barn, manufactured using the same, and a method for manufacturing the concrete slotted floor. Specifically, it relates to an “UHPC composition”, which is manufactured into an ultra high performance concrete having high strength and superior durability, exhibits superior crack resistance during casting even when it is manufactured such that an residing surface is located below because reinforcing fibers are uniformly distributed along the thickness direction of a member, can be demolded early due to fast initial setting time, and has maximized surface water repellency by containing an organic component. Further, the present disclosure relates to a concrete slotted floor for a barn. The concrete slotted floor is manufactured using the same, which exhibits superior structural performance and improved cleaning efficiency. The present disclosure also relates to a “method for manufacturing a concrete slotted floor a barn using the UHPC concrete composition”.

### 2. Description of the Related Art

A barn such as a pigsty, etc. has a concrete slotted floor that is above a certain height from the ground surface. In general, the existing concrete slotted floor has large volume and heavy weight because it is manufactured from ordinary concrete of moderate strength. For this reason, the work efficiency of transportation and installment of the concrete slotted floor is low and the cost of manufacturing and barn construction is high.

In addition, for the existing concrete slotted floor manufactured from the ordinary concrete of moderate strength, chemical erosion and corrosion occur on the surface where livestock are grown (“residing surface”) due to animal feces. As a result, frequent replacement or repair is required because of decreased life span and the cost of maintenance is increased greatly. In general, the animal feces on the residing surface is removed by high-pressure washing. During this process of high-pressure washing, concrete pieces are detached from the residing surface of the existing concrete slotted floor due to the use of high-pressure water spray. This exfoliation phenomenon worsens the condition of the residing surface and the concrete pieces exfoliated from the residing surface of the concrete slotted floor block the waste pipe of the barn. Especially, because the worsening of the residing surface of the concrete slotted floor increases the amount of animal feces sticking to the residing surface, cleaning becomes more difficult and the growth of livestock is affected negatively.

### SUMMARY

The present disclosure is directed to providing a technology for manufacturing a concrete member exhibiting superior structural performance using an ultra high performance concrete (UHPC) having high compressive strength, flexural strength and direct tensile strength by using a cement and a reinforcing steel fiber without use of a thick aggregate.

In particular, the present disclosure is directed to providing a technology, by manufacturing a concrete slotted floor used as a concrete member for a barn with the UHPC exhibiting superior performance, capable of greatly reducing the volume and weight of the concrete slotted floor and, thereby, allowing improvement of the work efficiency of transportation and installment and reducing the cost of manufacturing and barn construction.

The present disclosure is also directed to providing a technology for manufacturing a concrete slotted floor for a ban having superior wear resistance and chemical resistance and long endurance life, in order to solve the problems of the prior art of chemical erosion and corrosion on the residing surface of the concrete slotted floor, short endurance life, surface exfoliation phenomenon occurring during high-pressure washing, etc.

The present disclosure is also directed to providing a technology, by uniformly distributing reinforcing fibers along a thickness of a concrete member when manufacturing the concrete member such that the residing surface is located below, capable of providing superior overall structural performance to the concrete member.

The present disclosure provides an UHPC composition containing: a cement (Ordinary Portland Cement); 10-30 parts by weight of a binder including a reactive powder based on 100 parts by weight of the cement; 1-10 parts by weight of a CSA cement based on 100 parts by weight of the cement; 100-130 parts by weight of an aggregate based on 100 parts by weight of the cement; 10-30 parts by weight of a filler based on 100 parts by weight of the cement; 0.1-3 parts by weight of a silicone water repellent based on 100 parts by weight of the cement; 15-30 parts by weight of mixing water based on 100 parts by weight of the cement; and 1-6 parts by weight of a high-performance water reducing agent based on 100 parts by weight of the cement, wherein a mixture of a steel fiber and an organic fiber is used as a reinforcing fiber, and the UHPC composition exhibits a compressive strength of 100 MPa or higher.

The present disclosure also provides a concrete slotted floor manufactured using the UHPC composition described above, and a method for manufacturing the same.

In particular, in the present disclosure, the UHPC composition may contain 20 parts by weight of mixing water, 25 parts by weight of silica fume as a binder, 110 parts by weight of sand as an aggregate, 30 parts by weight of a filler, 2.3 parts by weight of a high-performance water reducing agent, 1 part by weight of a silicone water repellent and 5 parts by weight of a CSA cement based on 100 parts by weight of the cement; the organic fiber may be a PVA fiber having a length of 6 mm; the steel fiber may have a length of 20 mm; and the mixing ratio of the PVA fiber and the steel fiber in the reinforcing fiber may be 0.3:1 based on volume.

Since the UHPC composition according to the present disclosure has superior physical properties, a concrete member manufactured from the UHPC composition of the present disclosure exhibits superior crack resistance due to uniformly distributed reinforcing fibers while having high strength and superior durability.

In particular, since the UHPC composition according to the present disclosure has fast initial setting time, early demolding is possible and a concrete member can be manufactured in short time. Accordingly, the present disclosure can be very useful in manufacturing a concrete slotted floor for a ban and the UHPC composition according to the present disclosure may be used to improve the manufacturing efficiency of a concrete slotted floor for a ban and reduce manufacturing cost. In addition, since the UHPC composition of the present disclosure exhibits maximized surface water repellency owing to an organic component included therein, a concrete slotted floor manufactured using the UHPC composition of the present disclosure minimizes the exfoliation phenomenon of the residing surface even when high-pressure washing is performed to remove animal feces from the residing surface. Accordingly, durability is improved and the problem of blocking of the waste pipe of the barn by exfoliated concrete pieces can be prevented.

In addition, since the concrete slotted floor according to the present disclosure exhibits strong resistance to chemical erosion, life span is increased and the period of replacement/repair can be extended. As a result, maintenance cost can be reduced.

### BRIEF DESCRIPTION OF THE DRAWINGS

FIG. 1 schematically shows the cross-sectional distribution of an existing general fiber-reinforced concrete composition immediately after being cast in a mold for manufacturing of a concrete slotted floor.

FIG. 2 schematically shows the cross-sectional distribution of a UHPC composition according to the present disclosure immediately after being cast in a mold for manufacturing of a concrete slotted floor.

FIG. 3 shows displacement-flexural strength graphs for an example of the present disclosure and comparative examples.

FIG. 4 shows a result of measuring flexural strength for examples of the present disclosure and comparative examples depending on oiling treatment.

FIG. 5 shows a result of measuring initial setting time for examples of the present disclosure and comparative examples.

FIG. 6 shows a result of measuring water absorption for an example of the present disclosure and comparative examples.

FIG. 7 shows a result of measuring compressive strength for an example of the present disclosure and comparative examples.

### DETAILED DESCRIPTION

In the following description and claims and throughout the present specification, an ultra high performance concrete composition according to the present disclosure will be abbreviated as an “UHPC composition”. The UHPC composition of the present disclosure is very usefully used to manufacture concrete members of various shapes. When a concrete member is manufactured by casting the UHPC composition in a mold, very superior performance is achieved as reinforcing fibers are distributed uniformly on the cast upper surface and throughout the entire thickness in the vertical direction. Therefore, it can be very usefully used to manufacture a concrete member wherein a cast upper surface to be used is located below. An example of a concrete member wherein the surface that is actually used, i.e., the residing surface, becomes a cast lower surface during concrete casting and the surface located above during the casting, i.e., the cast upper surface, becomes a bottom surface during actual use is a “concrete slotted floor for a ban”. The UHPC composition of the present disclosure is very usefully used to manufacture the concrete slotted floor for a ban. For this reason, in the following description and claims and throughout the present specification, a “concrete slotted floor for a ban” is described as a representative example of a concrete member manufactured using the UHPC composition of the present disclosure. However, the concrete member manufactured using the UHPC composition of the present disclosure is not limited to such concrete slotted floor. Accordingly, in the present disclosure, the term “concrete slotted floor” is not limited to the concrete slotted floor actually used in a barn. It should be understood to include any “concrete member wherein the surface that is actually used, i.e., the residing surface, becomes a cast lower surface during concrete casting and the surface located above during the casting, i.e., the cast upper surface, becomes a bottom surface during actual use”.

The UHPC composition according to the present disclosure does not contain coarse aggregate but contains a cement, a fine aggregate and a reinforcing fiber. A concrete slotted floor manufactured from the UHPC composition of the present disclosure has a compressive strength of 120 MPa or higher, a bending strength of 15 MPa or higher and a direct tensile strength of 7 MPa or higher.

Specifically, the UHPC composition of the present disclosure contains: a cement (Ordinary Portland Cement, “OPC”); 10-30 parts by weight of a binder including a reactive powder based on 100 parts by weight of the cement; 1-10 parts by weight of a Calcium Sulfur Aluminate (CSA) cement based on 100 parts by weight of the cement; 100-130 parts by weight of an aggregate based on 100 parts by weight of the cement; 10-30 parts by weight of a filler based on 100 parts by weight of the cement; 0.1-3 parts by weight of a silicone water repellent based on 100 parts by weight of the cement; 15-30 parts by weight of mixing water based on 100 parts by weight of the cement; and 1-6 parts by weight of a high-performance water reducing agent based on 100 parts by weight of the cement, wherein a mixture of a steel fiber and an organic fiber is used as a reinforcing fiber, and the UHPC concrete composition exhibits a compressive strength of 100 MPa or higher.

In the present disclosure, a concrete slotted floor is manufactured by casting the UHPC composition in a mold designed according to the shape of the concrete slotted floor, followed by curing and demolding. The lower surface of the UHPC composition cast in the mold (“cast lower surface”) becomes a “residing surface” of the concrete slotted floor on which livestock will actually reside, and the upper surface of the UHPC composition cast in the mold (“cast upper surface”) becomes the opposite surface of the residing surface, i.e., a “bottom surface” where high tensile stress is applied. For health life and growth of livestock, it is necessary to form artificial patterns on the residing surface of the concrete slotted floor. In order to form artificial patterns, a mold plate on which the patterns can be formed should be located on the cast lower surface. For this reason, for a concrete slotted floor, the cast lower surface actually becomes the residing surface and the cast upper surface becomes the bottom surface. Besides the concrete slotted floor, there are various concrete members where the cast lower surface actually becomes the using surface for formation of artificial patterns on a wide area or other reasons.

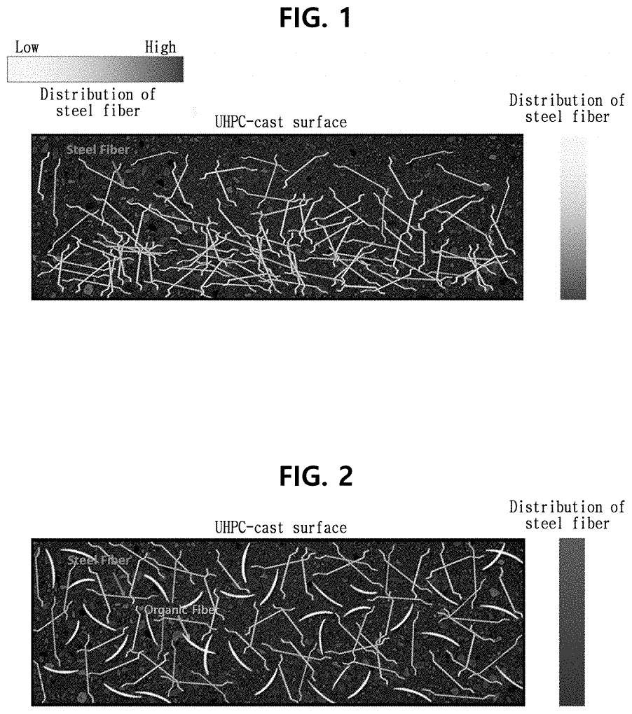

If only a steel fiber is used as the reinforcing fiber, the steel fiber is gathered on the cast lower surface due to the settlement of the steel fiber in a mold since the casting of the existing general fiber-reinforced concrete composition in the mold until initial setting. FIG. 1 schematically shows the cross-sectional distribution of an existing general fiber-reinforced concrete composition immediately after being cast in a mold for manufacturing of a concrete slotted floor. As shown in FIG. 1, when the existing general fiber-reinforced concrete composition using only a steel fiber as a reinforcing fiber is cast in a mold, the steel fiber is gathered toward the cast lower surface due to the settlement phenomenon owing to the weight of the steel fiber and a relatively smaller amount of the steel fiber is distributed on the cast upper surface. Due to the settlement phenomenon of the steel fiber, the steel fiber is not distributed sufficiently on the cast upper surface where high tensile stress is applied during the actual use of a concrete slotted floor. This decreases resistance to initial cracking or cracking during use.

In the present disclosure, in order to prevent this problem, a mixture of a steel fiber and an organic fiber is used as a reinforcing fiber. The organic fiber is mixed after special treatment (oiling treatment) in order to prevent the settlement of the steel fiber toward the cast lower surface since immediately after casting until initial setting. As a result, when a concrete slotted floor is manufactured by casting the UHPC composition in a mold, the reinforcing fiber is distributed uniformly throughout the whole thickness from the cast lower surface to the cast upper surface.

Specifically, in the present disclosure, the reinforcing fiber is a mixture of a steel fiber and an organic fiber at a volume ratio of 1:0.1 to 1:0.5. That is to say, a mixture consisting of 0.1-0.5 volume equivalent of an organic fiber per 1 volume equivalent of a steel fiber is used as a reinforcing fiber. The organic fiber improves the mechanical performance of concrete such as flexural strength, etc. by preventing shrinkage crack and inducing microcrack distribution through crosslinking of fibers. In particular, in the present disclosure, the organic fiber makes the steel fiber distributed uniformly on the cast upper surface and throughout the thickness by preventing the settlement of the steel fiber on the cast lower surface since immediately after casting until initial setting, as described above.

When the volume ratio of the organic fiber with respect to the steel fiber is 0.1 or higher, i.e., when a mixture consisting of 0.1 volume equivalent or more of the organic fiber per 1 volume equivalent of the steel fiber is used as a reinforcing fiber, the helpful effect of the addition of the organic fiber described above is achieved, and the advantageous effect is improved as the addition amount of the organic fiber is increased. However, if the organic fiber is added in an excess amount exceeding 0.5 volume equivalent per 1 volume equivalent of the steel fiber, constructability worsens as the slump flow of the UHPC composition is decreased rapidly and the “fiber ball” phenomenon of lumping of the steel fiber and the organic fiber occurs. The fiber ball makes it difficult to ensure uniform quality and, as a result, flexural strength is decreased. Accordingly, in the present disclosure, a mixture of a steel fiber and an organic fiber at a volume ratio of 1:0.1 to 1:0.5 is used as a reinforcing fiber.

Especially, in the present disclosure, an organic fiber with a length of 5-15 mm is used. If the length of the organic fiber is shorter than 5 mm, the effect described above is not achieved as desired. On the contrary, if it exceeds 15 mm, the slump flow of the UHPC composition decreases rapidly and, as a result, constructability worsens and the fiber ball phenomenon occurs. Accordingly, in the present disclosure, a mixture of a steel fiber and an organic fiber at a volume ratio of 1:0.1 to 1:0.5 is used, wherein the organic fiber has a length of 5-15 mm. Through this, toughness can be conferred to concrete and the prevention of destruction and cracking of the concrete due to drying shrinkage by the organic fiber can be ensured. In addition, the function of the organic fiber of making the steel fiber distributed uniformly on the cast upper surface and throughout the thickness by preventing the steel fiber from settling to the cast lower surface since immediately after casting until initial setting described above can be ensured.

FIG. 2 schematically shows the cross-sectional distribution of a UHPC composition according to the present disclosure immediately after being cast in a mold for manufacturing of a concrete slotted floor. As shown in FIG. 2, when a mixture of a steel fiber and an organic fiber of above-described volume ratio is used as a reinforcing fiber according to the present disclosure, the steel fiber is distributed uniformly through the entire thickness without the fiber ball phenomenon and, accordingly, the effect of the addition of the reinforcing fiber is ensured. In the present disclosure, a Polyvinyl alcohol (PVA) fiber, a Polyethylene (PE) fiber, a nylon fiber, etc. may be used as the organic fiber.

When using a mixture of a steel fiber and an organic fiber as a reinforcing fiber in the present disclosure, static electricity may be generated during the mixing of the components of the UHPC composition due to friction and, as a result, the organic fiber may be separated from other components. In the present disclosure, the organic fiber is subjected to oiling treatment to prevent this problem. Specifically, in the present disclosure, the organic fiber is oiling-treated by spraying a C₂₀₋₄₀ alkane-based mineral oil onto the surface of the organic fiber and then it is mixed with the steel fiber and other components.

In the present disclosure, by using the organic fiber after oiling treatment, the separation of materials can be prevented and the flexural strength performance of the concrete slotted floor can be very usefully improved through induction of stress distribution and microcracking and improvement of ductile behavior. Because the organic fiber molecules are easily adsorbed to fine metal hydroxide particles in alkaline conditions such as concrete, the organic fiber contained in the fiber-reinforced concrete composition allows superior chemical and frictional bonding to hardened concrete. But, if the bonding of the organic fiber to the hardened concrete is excessively superior, the strain hardening or multiple microcracking typically found in the fiber-reinforced concrete do not occur. It is because the tensile strength of the organic fiber fails to stand the high bond strength between the matrix and the organic fiber and, as a result, the organic fiber is fractured first.

In the present disclosure, a concrete slotted floor is manufactured by oiling-treating the organic fiber. This improves flexural strength performance by inducing the strain hardening whereby the organic fiber is released gradually at the interface between concrete and the organic fiber as flexural stress is applied during use of the concrete slotted floor, multiple cracks are induced on the lower surface of the concrete slotted floor during use of the concrete slotted floor and, accordingly, strain is increased after initial cracking as stress is increased.

In the present disclosure, the UHPC composition for manufacturing a concrete slotted floor contains 1-10 parts by weight of a CSA cement based on 100 parts by weight of the cement for reduction of initial setting time. Since the UHPC composition has a low water-cement ratio (W/B), a large amount of high-performance water reducing agent should be used to ensure self-consolidating constructability. But, if a large amount of high-performance water reducing agent is used, the initial setting time is increased to about 10-20 hours because cement hydration reaction is delayed. The increased initial setting time leads to increased settlement of the steel fiber included as a reinforcing fiber, increased time for demolding and, accordingly, decreased productivity of concrete slotted floor manufacturing using the UHPC composition. Accordingly, because the reduction of initial setting time is very important when manufacturing a concrete slotted floor using a UHPC composition, a CSA cement is used in the UHPC composition for manufacturing a concrete slotted floor in the present disclosure.

The compositions of Ordinary Portland cement (OPC) and the CSA cement used in the present disclosure are compared in Table 1. The main components of the CSA cement are CaO, Al₂O₃ and SO₃. The contents of CaO, Al₂O₃ and SO₃ are 40-45 wt %, 28-32 wt % and 8-15 wt %, respectively. In the present disclosure, 1-10 parts by weight of a CSA cement is included based on 100 parts by weight of the cement so as to reduce initial setting time to 30 minutes or shorter. If the content of the CSA cement is less than 1 part by weight, the effect of reducing initial setting time is insignificant. On the contrary, if the content of the CSA cement exceeds 10 parts by weight, it is difficult to ensure constructability due to quick setting during the mixing and stirring of the UHPC composition. Accordingly, in the present disclosure, the content of the CSA cement is set to 1-10 parts by weight.

TABLE 1

| | Chemical composition (wt %) | |
|---|---|---|
| Components | OPC | CSA cement |
| SiO₂ | 20.57 | 8.50 |
| Al₂O₃ | 4.98 | 30.43 |
| Fe₂O₃ | 3.39 | 2.08 |
| CaO | 60.74 | 41.82 |
| MgO | 2.64 | 2.21 |
| SO₃ | 2.38 | 11.95 |
| K₂O | 0.98 | 0.30 |
| Na₂O | 0.15 | 0.06 |
| TiO₂ | 0.27 | 1.50 |
| P₂O₅ | 0.11 | 0.15 |
| LOI | 3.67 | 0.75 |

In the UHPC composition according to the present disclosure, 0.1-3 parts by weight of a water repellent having silicone as a main component (“silicone water repellent”) is mixed based on 100 parts by weight of the cement. If the silicone water repellent is mixed, the surface of the concrete slotted floor becomes hydrophobic and, as a result, a liquid applied to the residing surface of the concrete slotted floor cannot flow into capillary pores. Therefore, the contamination of the residing surface of the concrete slotted floor can be minimized. In particular, the mixing of the silicone water repellent allows easy removal of contaminants such as excretions because their absorption and attachment are inhibited due to surface water repellency. If the silicone water repellent is contained in the UHPC composition of the present disclosure in an amount smaller than 0.1 part by weight, the contamination of the residing surface of the concrete slotted floor due to absorption and attachment cannot be prevented because the residing surface of the concrete slotted floor remains hydrophilic. In contrast, if the silicone water repellent is contained in an amount exceeding 3 parts by weight, mechanical performance such as compressive strength, flexural strength, etc. becomes unsatisfactory because it acts as a foreign material during the mixing of the components of the UHPC composition.

Next, an example according to the present disclosure and comparative examples for comparison are described. The composition of an example according to the present disclosure is described in Table 2. An UHPC composition according to an example of the present disclosure consists of a cement (ordinary Portland cement), silica fume as a binder including a reactive powder, a CSA cement, sand as an aggregate, a filler, a silicone water repellent, mixing water, a high-performance water reducing agent, and a mixture of a steel fiber and an organic fiber as a reinforcing fiber. A PVA fiber with a length of 6 mm was used as the organic fiber, and a steel fiber with a length of 20 mm was used. The UHPC composition according to an example of the present disclosure consisted of 20 wt % of mixing water, 25 wt % of silica fume, 110 wt % of sand, 30 wt % of filler, 2.3 wt % of a high-performance water reducing agent, 1 wt % of a water repellent and 5 wt % of a CSA cement based on 100 wt % of a cement. In the reinforcing fiber, the mixing ration of the steel fiber to the PVA fiber was 1:0.3 based on volume.

TABLE 2

| | | | | | High- | | | Steel | PVA |
|---|---|---|---|---|---|---|---|---|---|
| | | | | | performance | | | fiber | fiber |
| | | | | | water | | | (20 mm) | (6 mm) |
| | Mixing | Silica | | | reducing | Water | | (volume | (volume |
| Cement | water | fume | Sand | Filler | agent | repellent | CSA | ratio) | ratio) |
| 100 | 20 | 25 | 110 | 30 | 2.3 | 1 | 5 | 1 | 0.3 |

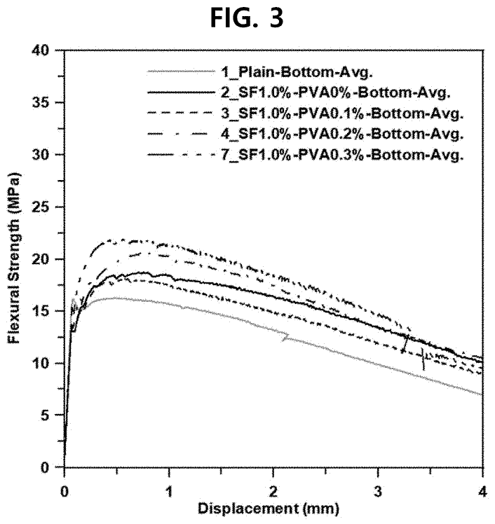

First, in order to investigate the effect of the mixing ratio (volume ratio) of the steel fiber and the organic fiber in the reinforcing fiber, comparative examples having the same composition as the UHPC composition according to an example of the present disclosure but containing no organic fiber or containing the organic fiber at different mixing ratios were prepared, and slump flow, compressive strength and flexural strength were analyzed for the example of the present disclosure and the comparative examples. The result is summarized in Table 3. In addition, the displacement-flexural strength graphs for the example of the present disclosure and the comparative examples are shown in FIG. 3.

TABLE 3

| Organic | Steel | Organic | | Com- | | |
|---|---|---|---|---|---|---|
| fiber | fiber | fiber | Slump | pressive | Flexural | |
| length | volume | volume | flow | strength | strength | |
| (mm) | ratio | ratio | (mm) | (MPa) | (MPa) | Remarks |
| Plain | 1 | 0 | 225 | 143 | 19.0 | |
| 6 | | 0.1 | 224 | 143 | 19.2 | |
| 6 | | 0.3 | 220 | 145 | 22.7 | |
| 6 | | 0.5 | 210 | 140 | 23.1 | |
| 6 | | 0.8 | 183 | 134 | 15.1 | Poor |
| | | | | | | (fiber ball) |
| 12 | | 0.1 | 224 | 142 | 18.7 | |
| 12 | | 0.3 | 213 | 137 | 22.4 | |
| 12 | | 0.5 | 205 | 135 | 22.9 | |
| 12 | | 0.8 | 167 | 110 | 14.8 | Poor |
| | | | | | | (fiber ball) |
| 20 | | 0.1 | 222 | 140 | 19.0 | Poor |
| | | | | | | (fiber ball) |
| 20 | | 0.3 | 210 | 135 | 22.0 | Poor |
| | | | | | | (fiber ball) |
| 20 | | 0.5 | 175 | 112 | 15.0 | Poor |
| | | | | | | (fiber ball) |
| 20 | | 0.8 | 130 | 95 | 14.8 | Poor |
| | | | | | | (fiber ball) |

As summarized in Table 3, when the length of the organic fiber was 6 mm or 12 mm, the effect on slump flow, compressive strength and flexural strength was advantageous as the mixing amount of the organic fiber was increased. However, when the length of the organic fiber was 20 mm, fiber ball was formed due to the mixing of the organic fiber.

In addition, as shown in the displacement-flexural strength relationship shown in FIG. 3, the example wherein the steel fiber and the organic fiber were mixed according to the present disclosure showed remarkably superior performance as compared to the comparative examples.

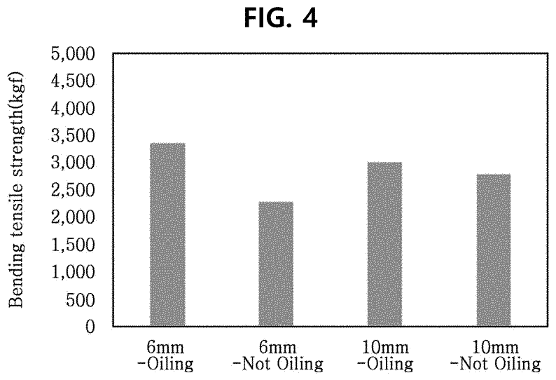

Next, in order to investigate the effect of oiling treatment on the organic fiber, UHPC compositions were prepared with the composition described in Table 1 and oiling-treated organic fibers with lengths of 6 mm and 10 mm as examples of the present disclosure. As comparative examples, those of the same composition but without oiling treatment were prepared. FIG. 4 shows a result of analyzing the flexural strength of the examples and comparative examples.

As seen from FIG. 4, the examples of the present disclosure wherein the organic fiber was oiling-treated showed improved flexural strength as compared to the comparative examples wherein the organic fiber was not oiling-treated, for both the cases where the length of the organic fiber was 6 mm and 10 mm.

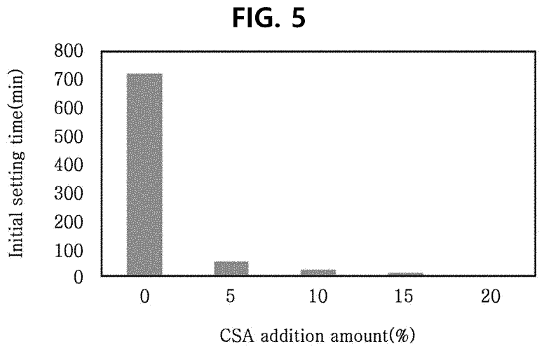

Next, in order to investigate the effect of the addition of a CSA cement, examples of the present disclosure and comparative examples were prepared with the same content, organic fiber addition amount and fiber length described in Table 1 but with varying content of the CSA cement, and initial setting time was measured for the examples of the present disclosure and comparative examples. The result is shown in Table 4 and FIG. 5.

TABLE 4

| OPC | CSA cement | Initial setting time |
|---|---|---|
| (parts by weight) | (parts by weight) | (minute) |
| 100 | 0 | 720 |
| | 5 | 55 |
| | 10 | 27 |
| | 15 | 13 |
| | 20 | Immeasurable |
| | | (quick setting occurred) |

As summarized in Table 4, a very long initial setting time was measured for the comparative example wherein the CSA cement was not added. On the contrary, the initial setting time was too short or quick setting occurred for the comparative examples wherein the CSA cement was added in excessive amount of 15 parts by weight or 20 parts by weight based on 100 parts by weight of OPC (cement).

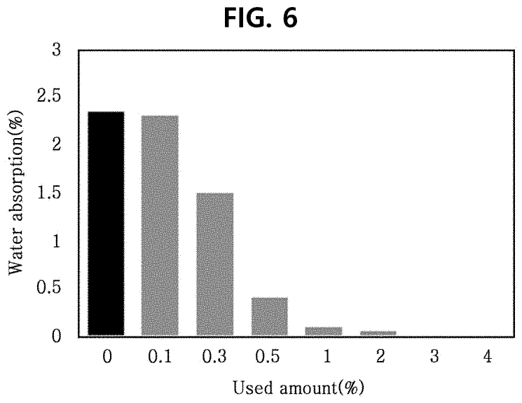

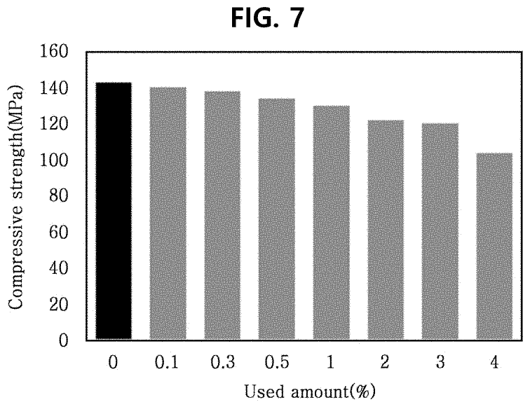

The UHPC composition of the present disclosure contains 0.1-3 parts by weight of a silicone water repellent based on 100 parts by weight of the cement. In order to investigate the effect of the addition amount of the silicone water repellent, examples of the present disclosure and comparative examples were prepared with the same content, organic fiber addition amount and fiber length described in Table 1 but with varying the content of the silicone water repellent, and water absorption and compressive strength were measured for the examples of the present disclosure and comparative examples. The result is shown in Table 5, FIG. 6 and FIG. 7.

TABLE 5

| Amount of silicone | Water | Compressive |
|---|---|---|
| water repellent | absorption | strength |
| (parts by weight) | (%) | (MPa) |
| 0 | 2.35 | 143 |
| 0.1 | 2.31 | 140 |
| 0.3 | 1.5 | 138 |
| 0.5 | 0.4 | 134 |
| 1 | 0.1 | 130 |
| 2 | 0.05 | 122 |
| 3 | 0.01 | 120 |
| 4 | 0 | 104 |

As can be seen from Table 5, FIG. 6 and FIG. 7, superior water repellency could be achieved with decreased water absorption without significant change in compressive strength when the addition amount of the silicone water repellent was within the range specified in the present disclosure.

As described above, since the UHPC composition according to the present disclosure has superior physical properties, a concrete slotted floor manufactured from the UHPC composition of the present disclosure has high strength and superior durability and exhibits superior crack resistance due to uniform distribution of reinforcing fibers. In addition, since the concrete slotted floor according to the present disclosure has superior durability, the exfoliation phenomenon of the residing surface is minimized even when high-pressure washing is performed to remove animal feces from the residing surface. Accordingly, the problem of blocking of the waste pipe of the barn by exfoliated concrete pieces can be prevented.

In particular, since the UHPC composition according to the present disclosure has fast initial setting time, early demolding is possible and a concrete member can be manufactured in short time. Accordingly, the manufacturing efficiency of a concrete slotted floor is improved and manufacturing cost is reduced. In addition, since the UHPC composition of the present disclosure exhibits maximized surface water repellency owing to an organic component included therein, the attachment of livestock excretions, etc. to the residing surface can be minimized and, as a result, cleaning efficiency is improved because low-pressure water can be used for washing.

In addition, since the concrete slotted floor according to the present disclosure exhibits strong resistance to chemical erosion, life span is increased and the period of replacement/repair can be extended. As a result, maintenance cost can be reduced.

1. An ultra high performance concrete composition comprising:
a cement;
10-30 parts by weight of a binder comprising a reactive powder based on 100 parts by weight of the cement;
1-10 parts by weight of a CSA cement based on 100 parts by weight of the cement;
100-130 parts by weight of an aggregate based on 100 parts by weight of the cement;
10-30 parts by weight of a filler based on 100 parts by weight of the cement;
0.1-3 parts by weight of a silicone water repellent based on 100 parts by weight of the cement;
15-30 parts by weight of mixing water based on 100 parts by weight of the cement; and
1-6 parts by weight of a high-performance water reducing agent based on 100 parts by weight of the cement,
wherein
a mixture of a steel fiber and an organic fiber is used as a reinforcing fiber, and
the ultra high performance concrete composition exhibits a compressive strength of 100 MPa or higher.

2. The ultra high performance concrete composition according to claim 1, wherein the reinforcing fiber is a mixture of a steel fiber and an organic fiber with a volume ratio of 1:0.1 to 1:0.5.

3. The ultra high performance concrete composition according to claim 1, wherein the organic fiber used in the reinforcing fiber has a length of 5-15 mm.

4. The ultra high performance concrete composition according to claim 1, comprising: 20 parts by weight of mixing water, 25 parts by weight of silica fume as a binder, 110 parts by weight of sand as an aggregate, 30 parts by weight of a filler, 2.3 parts by weight of a high-performance water reducing agent, 1 part by weight of a silicone water repellent and 5 parts by weight of a CSA cement, based on 100 parts by weight of the cement,
wherein
the organic fiber is a PVA fiber with a length of 6 mm;
the steel fiber has a length of 20 mm; and
the reinforcing fiber is a mixture of a steel fiber and a PVA fiber with a volume ratio of 1:0.3.

5. The ultra high performance concrete composition according to claim 1, wherein the organic fiber used in the reinforcing fiber is oiling-treated.

6. The ultra high performance concrete composition according to claim 5, wherein the oiling treatment of the organic fiber is performed by spraying a C₂₀₋₄₀ alkane-based mineral oil onto the surface of the organic fiber.

7. A concrete slotted floor manufactured from an ultra high performance concrete composition,
wherein the ultra high performance concrete composition comprises:
a cement;
10-30 parts by weight of a binder comprising a reactive powder based on 100 parts by weight of the cement;
1-10 parts by weight of a CSA cement based on 100 parts by weight of the cement;
100-130 parts by weight of an aggregate based on 100 parts by weight of the cement;
10-30 parts by weight of a filler based on 100 parts by weight of the cement;
0.1-3 parts by weight of a silicone water repellent based on 100 parts by weight of the cement;
15-30 parts by weight of mixing water based on 100 parts by weight of the cement; and
1-6 parts by weight of a high-performance water reducing agent based on 100 parts by weight of the cement,
wherein a mixture of a steel fiber and an organic fiber is used as a reinforcing fiber, and
the ultra high performance concrete composition exhibits a compressive strength of 100 MPa or higher.

8. The concrete slotted floor according to claim 7, wherein the reinforcing fiber in the ultra high performance concrete composition is a mixture of a steel fiber and an organic fiber at a volume ratio of 1:0.1 to 1:0.5.

9. The concrete slotted floor according to claim 7, wherein the organic fiber used in the reinforcing fiber has a length of 5-15 mm.

10. The concrete slotted floor according to claim 7, comprising: 20 parts by weight of mixing water, 25 parts by weight of silica fume as a binder, 110 parts by weight of sand as an aggregate, 30 parts by weight of a filler, 2.3 parts by weight of a high-performance water reducing agent, 1 part by weight of a silicone water repellent and 5 parts by weight of a CSA cement, based on 100 parts by weight of the cement,
wherein
the organic fiber is a PVA fiber with a length of 6 mm;
the steel fiber has a length of 20 mm; and
the reinforcing fiber is a mixture of a steel fiber and a PVA fiber with a volume ratio of 1:0.3.

11. The concrete slotted floor according to claim 7, wherein the organic fiber used in the reinforcing fiber is oiling-treated.

12. The concrete slotted floor according to claim 11, wherein the oiling treatment of the organic fiber is performed by spraying a C₂₀₋₄₀ alkane-based mineral oil onto the surface of the organic fiber.

13. A method for manufacturing a concrete slotted floor using an ultra high performance concrete composition,
wherein the ultra high performance concrete composition comprises:
a cement;
10-30 parts by weight of a binder comprising a reactive powder based on 100 parts by weight of the cement;
1-10 parts by weight of a CSA cement based on 100 parts by weight of the cement;
100-130 parts by weight of an aggregate based on 100 parts by weight of the cement;
10-30 parts by weight of a filler based on 100 parts by weight of the cement;
0.1-3 parts by weight of a silicone water repellent based on 100 parts by weight of the cement;
15-30 parts by weight of mixing water based on 100 parts by weight of the cement; and
1-6 parts by weight of a high-performance water reducing agent based on 100 parts by weight of the cement,
wherein a mixture of a steel fiber and an organic fiber is used as a reinforcing fiber,
the ultra high performance concrete composition exhibits a compressive strength of 100 MPa or higher, and
a concrete slotted floor is manufactured by casting the ultra high performance concrete composition in a mold such that the cast lower surface becomes a residing surface and the cast upper surface becomes a bottom surface, followed by curing and demolding.
